(19) United States
(12) Patent Application Publication
(10) Pub. No.: US 2026/0066591 A1
(43) Pub. Date: Mar. 5, 2026

(54) ELECTRIC WIRE UNIT AND METHOD OF ASSEMBLING ELECTRIC WIRE UNIT

(71) Applicant: YAZAKI CORPORATION, Tokyo (JP)

(72) Inventors: Hideki Mizuno, Kakegawa-shi (JP); Masanori Nakamura, Kakegawa-shi (JP); Shinichi Kamura, Kakegawa-shi (JP)

(21) Appl. No.: 19/317,031

(22) Filed: Sep. 2, 2025

(30) Foreign Application Priority Data
Sep. 3, 2024 (JP) 2024-151261

(51) Int. Cl. H01R 13/66; G01K 1/10; H01R 13/52; H01R 43/00

(52) U.S. Cl. CPC H01R 13/6683; G01K 1/10; H01R 13/5205; H01R 43/005

(57) ABSTRACT

An electric wire unit includes an electric wire, a terminal, a temperature sensor, and a waterproof member. The electric wire includes a conductor and an insulating sheath. The terminal includes an electric wire connection portion connected to the conductor of the electric wire. The temperature sensor detects the temperature of the electric wire connection portion. The waterproof member liquid-tightly covers the peripheries of the electric wire connection portion and the electric wire. The waterproof member is constituted by a sticky tape having an adhesive. The sticky tape having the adhesive is wound, in a state where the temperature sensor is in contact with the electric wire connection portion, around outer peripheral surfaces of the electric wire connection portion and the temperature sensor and an outer peripheral surface of the electric wire.

### BACKGROUND OF THE INVENTION

### Field of the Invention

Embodiments of the present invention relate to an electric wire unit and a method of assembling the electric wire unit.

Priority is claimed on Japanese Patent Application No. 2024-151261 filed in Japan on September 3, 2024, the content of which is incorporated herein by reference.

### Description of Related Art

A plurality of electric wire units are collectively used in a charging connector mounted on an electric vehicle or a hybrid vehicle. Each electric wire unit includes an electric wire having a conductor and an insulating sheath, and a metal terminal connected to the conductor of the electric wire. In the metal terminal, a terminal main body is formed on one end side in an axial direction, and an electric wire connection portion is formed on the other end side in the axial direction. The terminal main body constitutes, for example, a male terminal portion. In this case, the terminal main body can be fitted and connected to a female mating terminal.

In this type of electric wire unit, when a high voltage current flows through the conductor and the terminal for a long time, the temperature of the terminal and the electric wire becomes high. Therefore, it is important to detect the temperature of the electric wire connection portion of the terminal, and to appropriately control the current carrying portions and the like depending on the detected temperature.

As an electric wire unit, a unit including a temperature sensor at an electric wire connection portion of a terminal has been devised (see, for example, Patent Document 1).

In the electric wire unit described in Patent Document 1, a conductor of an electric wire is connected to the electric wire connection portion of the terminal in an inserted state, and the periphery of a butt portion between the electric wire connection portion and a sheath of the electric wire is covered with a waterproof shrinkable tube with an adhesive. The waterproof shrinkable tube is attached around the butt portion of between the electric wire connection portion and the sheath of the electric wire and is then heated. Heat causes the waterproof shrinkable tube to shrink and melts the adhesive, resulting in a liquid-tight seal being formed between the electric wire connection portion and the electric wire.

A temperature sensor is placed on an outer peripheral surface of the waterproof shrinkable tube. The temperature sensor is fixed to the outer peripheral surface of the waterproof shrinkable tube with a sensor-fixing shrinkable tube. Heat causes the sensor-fixing shrinkable tube to shrink, resulting in the temperature sensor being pressed against the outer peripheral surface of the waterproof shrinkable tube.

### Prior art document

### Patent document

[Patent Document 1]: Japanese Unexamined Patent Application, First Publication No. 2021-125339

### SUMMARY OF THE INVENTION

In the electric wire unit described in Patent Document 1, when the temperature sensor is attached, it is necessary to cover the peripheries of the temperature sensor and the electric wire connection portion with the sensor-fixing shrinkable tube while keeping the temperature sensor pressed against the outer peripheral surface of the waterproof shrinkable tube. However, it is difficult to stably maintain the temperature sensor at an appropriate position on the electric wire connection portion until the sensor-fixing shrinkable tube is shrunk by heating. In addition, in the electric wire unit described in Patent Document 1, it is necessary to fix the waterproof shrinkable tube to the terminal and the electric wire, and then to further fix the temperature sensor to the electric wire connection portion with the sensor-fixing shrinkable tube. Due to such steps, required man-hours of work for assembling components increase and the work becomes complicated.

Further, in the electric wire unit described in Patent Document 1, the temperature sensor is attached onto the waterproof shrinkable tube, which means that a separate member is interposed between the temperature sensor and the terminal that is a heat generator. Given such a configuration of the electric wire unit, it is desirable to more directly detect the temperature of the electric wire connection portion of the terminal from the viewpoint of more accurately detecting the temperature of the heat generator.

An embodiment of the present invention provides an electric wire unit and a method of assembling the electric wire unit, in which a temperature sensor can be easily fixed to an electric wire connection portion of a terminal in a stable posture in a state where the temperature sensor is in contact with the electric wire connection portion.

An electric wire unit according to an embodiment of the present invention includes: an electric wire that includes a conductor and an insulating sheath; a terminal that includes an electric wire connection portion that is connected to the conductor of the electric wire; a temperature sensor that detects a temperature of the electric wire connection portion; and a waterproof member that liquid-tightly covers peripheries of the electric wire connection portion and the electric wire, and the waterproof member is constituted by a sticky tape having an adhesive, the sticky tape being wound, in a state where the temperature sensor is in contact with the electric wire connection portion, around outer peripheral surfaces of the electric wire connection portion and the temperature sensor and an outer peripheral surface of the electric wire.

A method of assembling an electric wire unit according to an embodiment of the present invention is a method of assembling an electric wire unit including: an electric wire that includes a conductor and an insulating sheath; a terminal that includes an electric wire connection portion that is connected to the conductor of the electric wire; a temperature sensor that detects a temperature of the electric wire connection portion; and a waterproof member that liquid-tightly covers peripheries of the electric wire connection portion and the electric wire, and includes the steps of: bringing the temperature sensor into contact with the electric wire connection portion; temporarily fixing the temperature sensor and the electric wire connection portion by preparing, as the waterproof member, a sticky tape having an adhesive and by winding the sticky tape around outer peripheral surfaces of the electric wire connection portion and the temperature sensor and an outer peripheral surface of the electric wire; and fully fixing the temperature sensor and the electric wire connection portion with the adhesive of the sticky tape.

According to an electric wire unit and a method of assembling the electric wire unit of an embodiment of the present invention, a temperature sensor can be easily fixed to an electric wire connection portion of a terminal in a stable posture in a state where the temperature sensor is in contact with the electric wire connection portion.

### BRIEF DESCRIPTION OF THE DRAWINGS

FIG. 1 is a perspective view of a charging connector using an electric wire unit according to an embodiment;

FIG. 2 is a perspective view of the electric wire unit according to the embodiment;

FIG. 3 is a perspective view illustrating a procedure of assembling the electric wire unit according to the embodiment;

FIG. 4 is an exploded perspective view illustrating a portion of a modification example of the electric wire unit; and

FIG. 5 is a perspective view illustrating a portion of the modification example of the electric wire unit.

### DETAILED DESCRIPTION OF THE INVENTION

Hereinafter, an electric wire unit according to an embodiment will be described with reference to the drawings. In the following description, components having the same or similar functions are denoted by the same reference numbers. Redundant description of components denoted by the same reference numbers may be omitted.

In the present disclosure, terms are defined as follows. “Connection” is not limited to a mechanical connection and may include an electrical connection. In addition, “connection” is not limited to a case where two elements to be connected are directly connected to each other and may include a case where two elements to be connected are connected to each other with another element interposed therebetween.

### Charging Connector

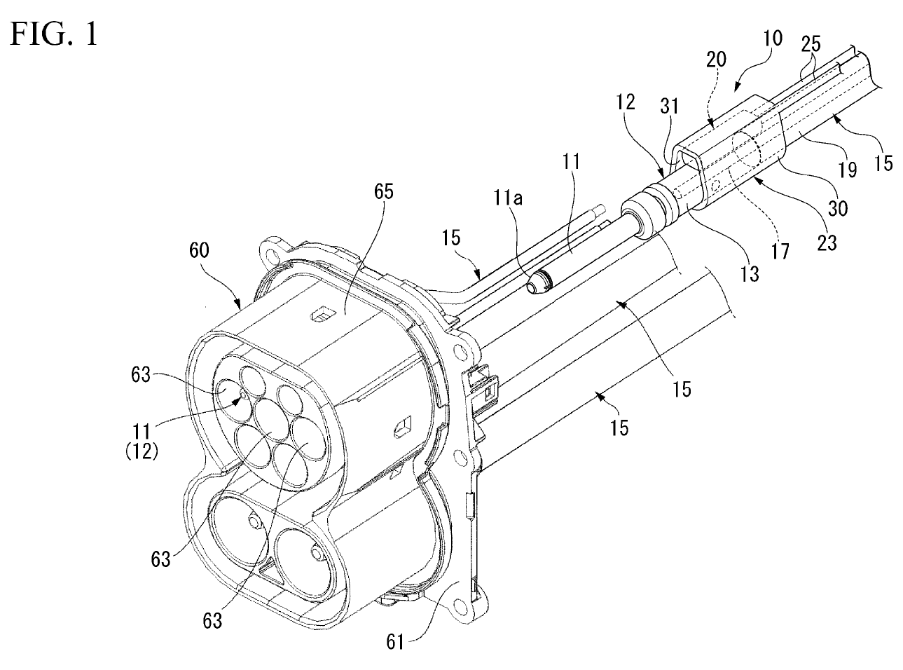

FIG. 1 is a perspective view of a charging connector 1 using an electric wire unit 10 according to the present embodiment. Note that FIG. 1 illustrates a state in which one of electric wire units 10 is separated from a connector body 60.

The charging connector 1 illustrated in FIG. 1 is a connector mounted on an electric vehicle or a hybrid vehicle. The charging connector 1 includes the connector body 60 made of resin and a plurality of electric wire units 10 attached to the connector body 60. The connector body 60 includes a columnar portion 65 protruding in one direction and a flange 61 provided to extend outward from the outer periphery of a base of the columnar portion 65. The flange 61 can be fixed to an edge of an opening (not illustrated) of a connector installation portion on a vehicle side. In an inner region of the columnar portion 65, a plurality of terminal housing holes 63 are formed each to house a portion (a terminal main body 11 to be described later) of an electric wire unit 10.

Hereinafter, in the charging connector 1, for convenience of description, a side toward which the columnar portion 65 protrudes from the flange 61 is referred to as “front”, and a side opposite to the side toward which the columnar portion 65 protrudes is referred to as “rear”. In addition, in each electric wire unit 10, a direction aligned with a direction toward the front side in the charging connector 1 is referred to as “front”, and a direction aligned with a direction toward the rear side in the charging connector 1 is referred to as “rear”.

### Electric Wire Unit

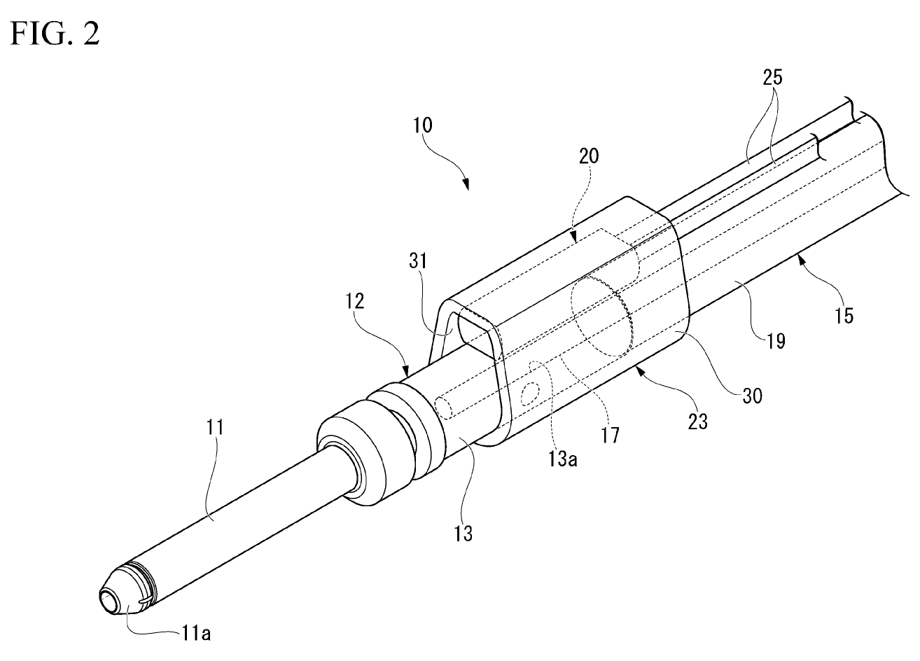

FIG. 2 is a perspective view of an individual electric wire unit 10.

The electric wire unit 10 includes a terminal 12 made of a conductive metal having a terminal main body 11 that is columnar and male type, an electric wire 15 having one end connected to the terminal 12, a temperature sensor 20 that detects the temperature of the terminal 12, and a sticky tape 23 with an adhesive that constitutes a waterproof member. As illustrated in FIG. 1, in the electric wire unit 10, the terminal main body 11 of the terminal 12 is inserted into a corresponding terminal housing hole 63 of the connector body 60 from the rear side of the connector body 60. Each electric wire unit 10 is fixed to the connector body 60 in this state. An end of the electric wire 15 opposite to the terminal 12 is connected to a charging circuit or the like for charging a battery (not illustrated).

In the present embodiment, the electric wire unit 10 is used for the charging connector 1 mounted on a vehicle, but the application of the electric wire unit 10 is not limited to the charging connector 1. The electric wire unit 10 can also be applied to various other devices.

The electric wire 15 includes a conductor 17 and an insulating sheath 19 that is an insulator covering the periphery of the conductor 17. A terminal portion of the conductor 17 to which the terminal 12 is connected is exposed at a certain length from the insulating sheath 19 in advance. The conductor 17 is formed of a conductive metal wire material. As the conductor 17, a stranded wire having a plurality of strands or a solid wire can be used.

In the terminal 12, the columnar terminal main body 11 is formed on the front end side, and an electric wire connection portion 13 is formed on the rear end side of the terminal main body 11. The terminal main body 11 constitutes a male terminal that is inserted and connected to a mating terminal fitting (a female terminal) (not illustrated). The terminal main body 11 is electrically connected to the mating terminal fitting by being inserted and connected to the mating terminal fitting. At the front end of the terminal main body 11, an insertion guide 11a is formed to be tapered (reduced in diameter toward the tip) for facilitating insertion into the mating terminal fitting.

The electric wire connection portion 13 of the terminal 12 has a columnar shape. The electric wire connection portion 13 has a conductor insertion hole 13a formed from the rear end side. The conductor 17 exposed at one end of the electric wire 15 is inserted into the conductor insertion hole 13a. The electric wire connection portion 13 is appropriately swaged in this state to be connected to the conductor 17 of the electric wire 15. The conductor 17 of the electric wire 15 and the terminal 12 are electrically connected to each other in this state.

The temperature sensor 20 is configured by, for example, a contact type temperature sensor such as a thermistor. A detection line 25 leading to a sensor body is drawn out from the rear end of the temperature sensor 20. The detection line 25 is connected to a detection board (not illustrated). The temperature sensor 20 is fixed to the electric wire connection portion 13 in a state of being in contact with an outer peripheral surface of the electric wire connection portion 13 of the terminal 12. The temperature sensor 20 is fixed to the electric wire connection portion 13 with the sticky tape 23 with the adhesive.

Note that the temperature sensor 20 is not limited to a thermistor and may be another contact type temperature sensor such as a bimetal sensor.

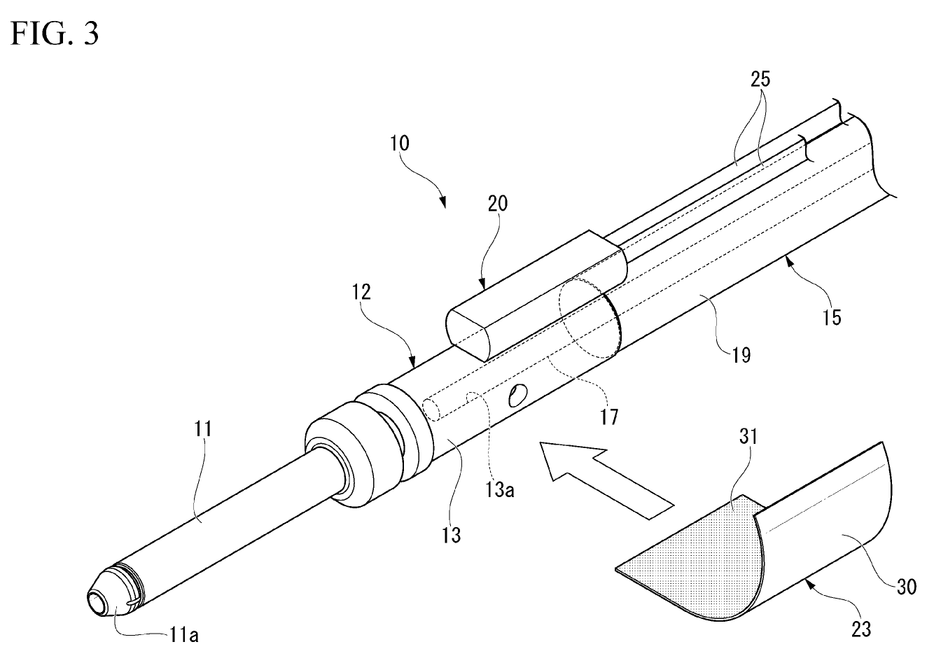

FIG. 3 is an exploded perspective view illustrating a procedure of assembling the electric wire unit 10. FIG. 3 illustrates how the temperature sensor 20 is temporarily fixed to the electric wire connection portion 13 of the terminal 12 with the sticky tape 23 with the adhesive.

In the sticky tape 23 with the adhesive, an adhesive 31 having liquid tightness is applied to one surface of a sheet-like tape body 30 (a surface that is on the inside when it is wound around the temperature sensor 20 and the outside of the terminal 12 and the outside of the electric wire 15). The tape body 30 is formed of, for example, polyethylene. As the adhesive 31, a thermoplastic adhesive can be adopted. For example, (a) and (b) below can be adopted as the adhesive 31.

(a) Polyamide, ethylene acrylic acid copolymer (10 wt%)

(b) Nylon, ethylene acrylic acid copolymer (10 wt%)

The adhesive 31 applied to the tape body 30 can be melted by heating to closely adhere to a plurality of members as adhesion targets and then be solidified by cooling to fix the plurality of members to each other.

As the adhesive 31 applied to the back surface (the above-described one surface) of the tape body 30, an adhesive having stickiness on the surface at normal temperature (for example, 20°C ± 15°C) is adopted. It should be noted that, an adhesive 31 having no stickiness at normal temperature may be adopted, and another sticky agent may be applied to the surface of the tape body 30 or the adhesive 31.

### Method of Assembling Electric Wire Unit

Next, a method of assembling the electric wire unit 10 will be described with reference to FIG. 3.

The electric wire unit 10 can be assembled as follows.

(1) The end of the conductor 17 of the electric wire 15 is connected to the electric wire connection portion 13 of the terminal 12 in advance. (2) The temperature sensor 20 in this state is brought into contact with an outer peripheral surface of the electric wire connection portion 13.

(3) The sticky tape 23 with the adhesive is prepared, and the sticky tape 23 is wound around outer peripheral surfaces of the electric wire connection portion 13 and the temperature sensor 20 and an outer peripheral surface of the electric wire 15 at the end side. At this time, overlapping tape portions of the wound sticky tape 23 are fixed to each other due to the stickiness on the back surface of the sticky tape 23. As a result, the temperature sensor 20 is temporarily fixed on the outer peripheral surface of the electric wire connection portion 13 in a stable posture with the sticky tape 23.

(4) Thereafter, the thermoplastic adhesive 31 applied to the sticky tape 23 is heated to a predetermined temperature to be melted. At this time, the adhesive 31 closely adheres to the periphery of a butt portion between the electric wire connection portion 13 and the electric wire 15 and to the temperature sensor 20 inside the tape body 30. As a result, the periphery of the butt portion between the electric wire connection portion 13 and the electric wire 15 is liquid-tightly covered with the adhesive 31. In addition, when the melted adhesive 31 is solidified by cooling, the temperature sensor 20 is fully fixed to the outer peripheral surface of the electric wire connection portion 13 by means of the adhesive 31.

### Operation and Effect

In the electric wire unit 10 of the present embodiment, the waterproof member covering the peripheries of the electric wire connection portion 13 and the electric wire 15 is constituted by the sticky tape 23 with the adhesive. The sticky tape 23 is wound, in a state where the temperature sensor 20 is in contact with the electric wire connection portion 13, around the outer peripheral surfaces of the electric wire connection portion 13 and the temperature sensor 20 and the outer peripheral surface of the electric wire 15. At this time, in the electric wire unit 10, a sticky portion of the sticky tape 23 with the adhesive is brought into contact with an overlapping tape portion and the other members, so that the temperature sensor 20 can be temporarily fixed to the electric wire connection portion 13 of the terminal 12 in a stable posture. In this state, the adhesive 31 in the melted state closely adheres to the peripheries of the electric wire connection portion 13 and the electric wire 15. Then, the adhesive 31 of the sticky tape 23 is solidified, resulting in a liquid-tight seal being formed between the electric wire connection portion 13 and the electric wire 15, and the temperature sensor 20 being fixed directly to the outer peripheral surface of the electric wire connection portion 13. This allows the temperature sensor 20 to directly detect a temperature state of the electric wire connection portion 13 of the terminal 12.

Therefore, when the electric wire unit 10 of the present embodiment is adopted, the temperature sensor 20 can be easily fixed to the electric wire connection portion 13 of the terminal 12 in a stable posture in a state where the temperature sensor 20 is in contact with the electric wire connection portion 13.

Further, in the electric wire unit 10 of the present embodiment, a thermoplastic adhesive is adopted as the adhesive 31 applied to the sticky tape 23. Such an adhesive eliminates the concern about dropping of the adhesive 31 or the like when the sticky tape 23 is wound around the temperature sensor 20, the electric wire connection portion 13 of the terminal 12, and the like, which leads to easy handling. After the sticky tape 23 is wound around the temperature sensor 20, the electric wire connection portion 13 of the terminal 12, and the like, the adhesive 31 can be melted by heating from the outside to closely adhere to the adhesion targets. Therefore, when this configuration is adopted, the sticking work of the sticky tape 23 can be facilitated.

Further, in the electric wire unit 10 of the present embodiment, an adhesive having stickiness on the surface at normal temperature is adopted as the adhesive 31 applied to the sticky tape 23. This adhesive eliminates the need to apply two types of materials to the tape body 30 of the sticky tape 23: an adhesive for full fixing and a sticky agent for temporary fixing. Therefore, when this configuration is adopted, the sticky tape 23 with the adhesive can be more easily manufactured.

In the method of assembling the electric wire unit 10 of the present embodiment, the temperature sensor 20 is fixed to the electric wire connection portion 13 of the terminal 12 through the above-described steps (1) to (4). Therefore, when the assembling method of the present embodiment is adopted, the temperature sensor 20 can be easily fixed to the electric wire connection portion 13 of the terminal 12 in a stable posture in a state where the temperature sensor 20 is in contact with the electric wire connection portion 13.

### Modification Example

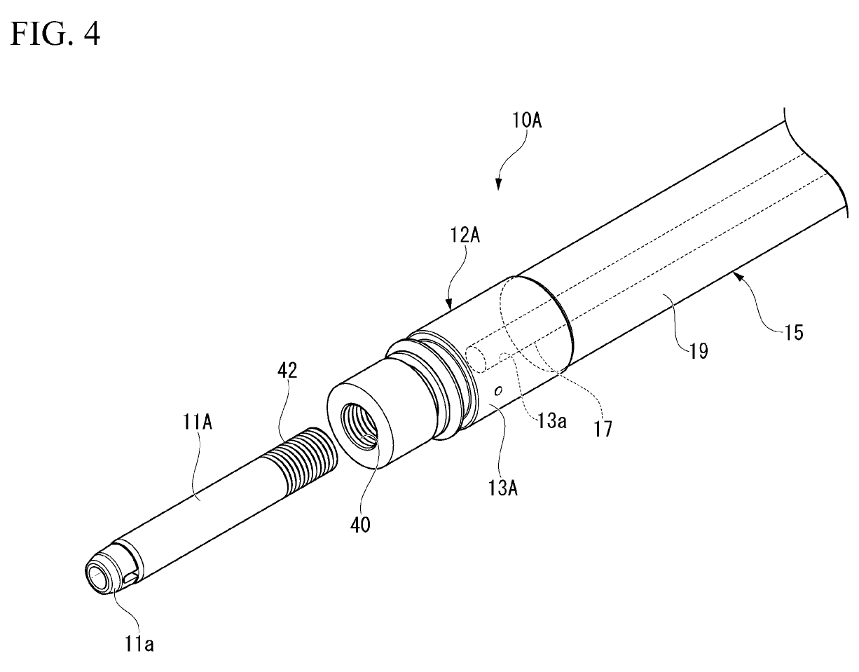

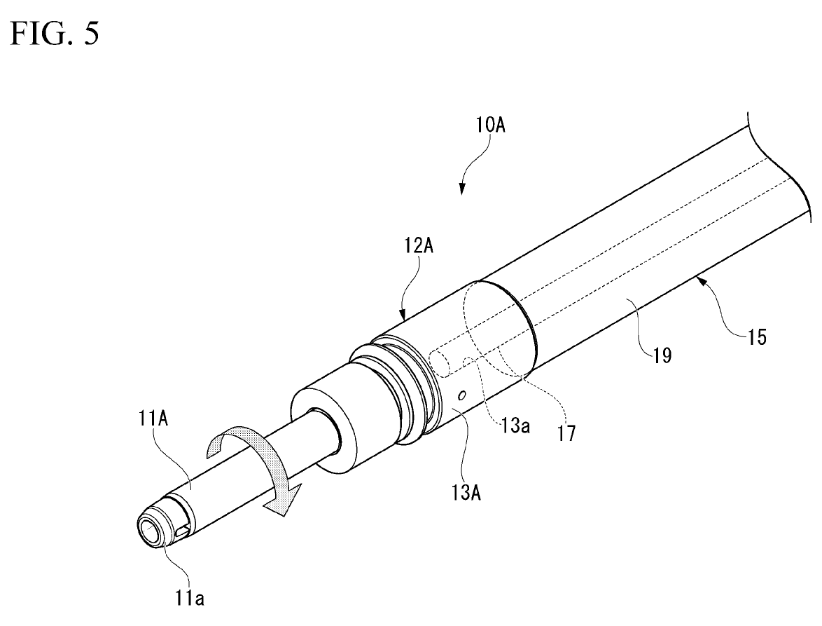

FIG. 4 is an exploded perspective view of a portion of an electric wire unit 10A of a present modification example, and FIG. 5 is a perspective view of a portion of the electric wire unit 10A of the present modification example after components are assembled.

The electric wire unit 10A of the present modification example has a terminal 12A of which configuration is different from that of the terminal 12 of the above-described embodiment. The other component configurations are similar to those of the above-described embodiment. In FIGS. 4 and 5, a temperature sensor and a sticky tape having an adhesive are omitted.

The terminal 12A of the present modification example includes, as separate components, an electric wire connection portion 13A to which the electric wire 15 is connected and a male terminal main body 11A that is inserted into a mating terminal. In the columnar electric wire connection portion 13A, a screw hole 40 is formed in an end surface opposite to a side to which the electric wire 15 is connected. The screw hole 40 is internally threaded. In the terminal main body 11A, a male screw 42 is formed on the outer periphery of an end opposite to a side where a tapered insertion guide 11a is located. As illustrated in FIG. 5, the male screw 42 portion of the terminal main body 11A can be fastened and fixed to the screw hole 40 of the electric wire connection portion 13A. That is, in the terminal 12A of the present modification example, the terminal main body 11A is attachable to and detachable from the electric wire connection portion 13A.

In the terminal 12A of the present modification example, electric wire connection portions 13A of a plurality of specifications with different outer diameters and different conductor insertion hole 13a inner diameters can be properly connected and used with the terminal main body 11A of a single specification.

Normally, the terminal main body 11A is repeatedly inserted into and removed from a mating terminal (female terminal), and thus it is necessary to apply thick plating on the outer surface of the terminal main body 11A. On the other hand, it is not necessary to apply plating on an electric wire connection portion as thick as that on a terminal main body. However, in a case where a terminal main body and an electric wire connection portion are configured as a single component, plating applied on the electric wire connection portion would naturally have the same thickness as that on the terminal main body.

In the terminal 12A of the present modification example, since the terminal main body 11A and the electric wire connection portion 13A are configured as separate components, plating applied on the electric wire connection portion 13A can be thinner than plating applied on the terminal main body 11A.

In addition, outer diameters of electric wire conductors normally differ depending on the magnitude of the current to be used. Due to such a difference in outer diameter, when currents with different current values are used, it is required to use electric wires of different specifications and to use terminals to be connected to the electric wires which conform to the specifications of the electric wires. Such requirements necessitate production of a terminal of a different specification for each current value of the current to be used, which is not desirable from the viewpoint of production efficiency.

In the terminal 12A of the present modification example, since the terminal main body 11A and the electric wire connection portion 13A are configured as separate components, even when a current with a different current value is used, the terminal main body 11A of a common specification can be used. That is, the terminal main body 11A of a common specification can be used, and only for an electric wire connection portion 13A, one corresponding to the specification of the electric wire 15 can be used. With such a separate-component configuration, the terminal main body 11A can be efficiently produced in large quantities by common equipment.

Therefore, in the terminal 12A of the present modification example, the thickness of plating applied to the electric wire connection portion 13A can be set to a necessary and sufficient level, and the terminal main body 11A to which thick plating is applied can be shared by a plurality of types of terminals of different specifications. This means that, when the terminal 12A of the present modification example is adopted, the production efficiency of the terminal 12A can be further enhanced.

Although an embodiment of the present disclosure has been described above, this embodiment is shown as an example and is not intended to limit the scope of the present disclosure. This embodiment can be implemented in various other forms, and various omissions, substitutions, and changes can be made without departing from the gist of the present disclosure.

### INDUSTRIAL APPLICABILITY

According to the present disclosure, a temperature sensor can be easily fixed to an electric wire connection portion of a terminal in a stable posture in a state where the temperature sensor is in contact with the electric wire connection portion.

### REFERENCE SIGNS LIST

10, 10A Electric wire unit

12, 12A Terminal

13 Electric wire connection portion

15 Electric wire

17 Conductor

19 Insulating sheath

20 Temperature sensor

23 Sticky tape having adhesive

31 Adhesive

What is claimed is:

1. An electric wire unit comprising:
an electric wire that includes a conductor and an insulating sheath;
a terminal that includes an electric wire connection portion that is connected to the conductor of the electric wire;
a temperature sensor that detects a temperature of the electric wire connection portion; and
a waterproof member that liquid-tightly covers peripheries of the electric wire connection portion and the electric wire,
wherein the waterproof member is constituted by a sticky tape having an adhesive, the sticky tape being wound, in a state where the temperature sensor is in contact with the electric wire connection portion, around outer peripheral surfaces of the electric wire connection portion and the temperature sensor and an outer peripheral surface of the electric wire.

2. The electric wire unit according to claim 1, wherein the adhesive provided to the sticky tape is a thermoplastic adhesive.

3. The electric wire unit according to claim 1, wherein the adhesive applied to the sticky tape is an adhesive having stickiness on a surface at normal temperature.

4. A method of assembling an electric wire unit, the electric wire unit including:
an electric wire that includes a conductor and an insulating sheath;
a terminal that includes an electric wire connection portion that is connected to the conductor of the electric wire;
a temperature sensor that detects a temperature of the electric wire connection portion; and
a waterproof member that liquid-tightly covers peripheries of the electric wire connection portion and the electric wire,
the method comprising the steps of:
bringing the temperature sensor into contact with the electric wire connection portion;
temporarily fixing the temperature sensor and the electric wire connection portion by preparing, as the waterproof member, a sticky tape having an adhesive and by winding the sticky tape around outer peripheral surfaces of the electric wire connection portion and the temperature sensor and an outer peripheral surface of the electric wire; and
fully fixing the temperature sensor and the electric wire connection portion with the adhesive of the sticky tape.
